(19) United States
(12) Patent Application Publication
(10) Pub. No.: US 2010/0217980 A1
(43) Pub. Date: Aug. 26, 2010

(54) Communication Control System, Mobile Communication Terminal and Computer Program

(75) Inventors: Satoshi Komorita, Fujimino-shi (JP); Tsunehiko Chiba, Fujimino-shi (JP); Hidetoshi Yokota, Fujimino-shi (JP)

Correspondence Address: MORGAN LEWIS & BOCKIUS LLP, 1111 PENNSYLVANIA AVENUE NW, WASHINGTON, DC, 20004, US

(73) Assignee: KDDI CORPORATION, Tokyo (JP)

(21) Appl. No.: 12/522,522

(22) PCT Filed: Dec. 28, 2007
(86) PCT No.: PCT/JP2007/075274

§ 371 Date: Jul. 8, 2009

(30) Foreign Application Priority Data
Jan. 10, 2007 (JP) 2007-002876

(51) Int. Cl. G06F 21/00; H04L 9/32; H04W 4/00; G06F 15/16

(52) U.S. Cl. 713/168; 726/4; 370/328; 709/227

(57) ABSTRACT

In order to reduce the registration time of a Mobile IP/Simple IP and an SIP, an AAA (14) which receives a Mobile IP registration request message from a mobile node (10), authorizes the mobile node and generates the authentication information regarding the authentication, a FA (12) which transmits the authentication information to the mobile node (10), and an S-CSCF (17) which receives an SIP registration request message to which the authentication information is attached from the mobile node (10), checks the received authentication information and transmits an SIP registration completion message addressed to the mobile node are provided.

### TECHNICAL FIELD

The present invention relates to a communication control system, a mobile communication terminal and a computer program.

Priority is claimed on Japanese Patent Application No. 2007-002876, filed Jan. 10, 2007, the content of which is incorporated herein by reference.

### BACKGROUND ART

In recent years, several methods have been discussed that realize multimedia services, that is, for example, IMS (IP Multimedia Subsystem) or MMD (Multi Media Domain) (hereinafter, “IMS/MMD”). In IMS/MMD, there is a technique in which a Mobile IP (Mobile Internet Protocol) and an SIP (Session Initiation Protocol) are used. The Mobile IP provides a handover technique which can achieve a communication without interruption even if a mobile node (MN) is carried across independent “Visited Networks”. In order to cut off unnecessary communication, the SIP provides a communication control technique which controls communication sessions and gives only the allowed session permission to conduct communication.

In the IMS/MMD, when the mobile node establishes an initial connection or conducts a handover operation to connect to the “Visited Network”, the Mobile IP and SIP are registered at the “Visited Network”. After registering the Mobile IP and SIP, the mobile node can start communication. FIGS. 10 and 11 are a block diagram and a sequence chart, respectively, that explain a registration constitution of the conventional Mobile IP and SIP in the IMS/MMD.

In reference to FIGS. 10 and 11, a conventional registration method of the Mobile IP and SIP is explained. In FIG. 10, a mobile node 100 conducts a handover operation while moving from a “Visited Network (200)” to a “Visited Network (100)”. A “Visited Network (101)” provides a FA (Foreign Agent) 102 and a P-CSCF (Proxy Call Session Control Function) 106. A “Home Network (103)” of the mobile node 100 provides an AAA (Authentication Authorization Accounting) 104, an HA (Home Agent) 105, an S-CSCF (Serving Call Session Control Function) 107 and an HSS (Home Subscriber Server) 108. The “Visited Network (101)”, “Visited Network (200)” and “Home Network (103)” are mutually connected via a router 201. It should be noted that there is a possibility in which the P-CSCF 106 is provided by the “Home Network (103)”.

After conducting a handover to the “Visited Network (101)”, the mobile node 100 registers Mobile IP to an HA 105 of the “Home Network (103)” via a FA 102 of the “Visited Network (101)”. Steps S11-S16 of FIG. 11 show this registration procedure of the Mobile IP. First, the mobile node 100 transmits a Mobile IP registration request message to the FA 102 (S11). When receiving the Mobile IP registration request message, the FA 102 transmits a RADIUS (Remote Authentication Dial-In User Service) access request message to the AAA 104 (S12). When receiving the RADIUS access request message, the AAA 104 conducts an authentication operation regarding the mobile node and transmits a RADIUS access acceptance message to the FA 102 if the authentication is successful (S13). When receiving the RADIUS access acceptance message, the FA 102 transmits a Mobile IP registration request message to the HA 105 (S14). When receiving the Mobile IP registration request message, the HA 105 conducts a registration operation in accordance with the request and replies a Mobile IP registration reply message to the FA 102 (S15). When receiving the Mobile IP registration reply message, the FA 102 transmits the Mobile IP registration reply message to the mobile node 100 (S16). Here, a registration of the mobile node 100 to the HA 105 is completed. After registering the Mobile IP, “Reverse Tunneling” as shown in FIG. 10 is provided for packet transmitting operations. Hereinafter, both the packets transmitted from the mobile node 100 and the packets transmitted to the mobile node 100 are transmitted by using the provided “Reverse Tunneling”. In a practical case, the packets transmitted from the mobile node 100 is transmitted to the HA 105 of the “Home Network (103)”, and then, transmitted to a target node. Similarly, a packet which is going to be transmitted to the mobile node 100 is transmitted to the HA 105 of the “Home Network (103)”, and then, transmitted to the mobile node 100.

Next, via the P-CSCF 106 of the “Visited Network (101)”, the mobile node 100 registers the SIP to the S-CSCF 107 of the “Home Network (103)”. Steps S21-S36 of FIG. 11 show this registration operation of the SIP. First, the mobile node 100 prepares an SIP registration request message which is addressed to the S-CSCF 107 via the P-CSCF 106 and transmits the message via the FA 102 (S21). The SIP registration request message is retransmitted by “Reverse Tunneling” of the Mobile IP to the P-CSCF 106 via the HA 105 (S22). The P-CSCF 106 transmits the retransmitted SIP registration request message to the S-CSCF 107 (S23). When the S-CSCF 107 receives the SIP registration request message, the S-CSCF 107 requests node information to the HSS 108 regarding the mobile node from which the request message is originally transmitted (S24). In response to the request, the HSS 108 replies the node information of the mobile node to the S-CSCF 107 (S25). When the S-CSCF 107 receives the node information, the S-CSCF 107 generates both a message for a challenge-response authentication with regard to the mobile node and a key for encryption used upon communicating after the SIP registration and transmits them to the P-CSCF 106 by attaching them to an SIP registration unauthorized message addressed to the mobile node 100 (S26). When the P-CSCF 106 receives the SIP registration unauthorized message, the P-CSCF 106 transmits the message to the mobile node 100 (S27). The SIP registration unauthorized message is retransmitted to the FA 102 via the HA 105 by using the “Reverse Tunneling” (S27). The FA 102 transmits the retransmitted SIP registration unauthorized message to the mobile node 100 (S28).

After this, when receiving the SIP registration unauthorized message, the mobile node 100, by using a secret key stored as its own node information, encrypts the message for a challenge-response authentication attached to the SIP registration unauthorized message and transmits the SIP registration request message through the FA 102 that is generated by encryption and that is addressed to the S-CSCF 107 via the P-CSCF 106 (S29). The encrypted SIP registration request message is retransmitted to the P-CSCF 106 via the HA 105 by using the “Reverse Tunneling” (S30) and is transmitted to the S-CSCF 107 from the P-CSCF 106 (S31). When receiving the encrypted SIP registration request, the S-CSCF 107 conducts a challenge-response authorization on the mobile node and requests a node registration of the mobile node to the HSS 108 if the authorization is successful (S32). In response to the request, the HSS 108 conducts a node registration and responds a node registration reply message to the S-CSCF 107 (S33). When receiving the node registration reply message, the S-CSCF 107 transmits an SIP registration completion message which is addressed to the mobile node 100 to the P-CSCF 106 (S34). When receiving the SIP registration completion message, the P-CSCF 106 transmits the SIP registration completion message which is addressed to the mobile node 100 (S35). The SIP registration completion message is retransmitted to the FA 102 via the HA 105 by using the “Reverse Tunneling” (S35) and is transmitted to the mobile node 100 from the FA 102 (S36). Here, an SIP registration of the mobile node 100 to the S-CSCF 107 is completed. After this, the mobile node 100 can communicate on the “Visited Network”.

However, in the above-described registration method of the Mobile IP and SIP, there is a problem in which it is difficult to reduce registration time. This is because, when registering SIP, communication via “Home Network” is conducted many times by “Reverse Tunneling”, and there is a possibility in which such an operation increases communication delay. In operation steps shown in FIG. 11, there is such communication four times, that are, Steps S22, S27, S30 and S35. In addition, such an operation time is long because a registration of a mobile node is conducted individually when registering the Mobile IP and registering the SIP. Not only the Mobile IP, there is a similar problem with regard to a general IP (called “Simple IP”).

[Non-patent Document] “Practical and Entry Level Network IMS (IP Multimedia Subsystem) Standard Textbook NGN Core Technology (translated by Takuya Sawada and Takuya Kashima)”, RIC TELECOM, Jul. 16, 2006, Gonzalo Camarillo, Miguel A. Garcia-Martin

The present invention was conceived in order to solve the above-described problems and has an object to provide a communication control system and a mobile communication terminal that can reduce a registration time of a Mobile IP/Simple IP and an SIP.

In addition, the present invention has another object to provide a computer program for realizing the communication control system of the present invention by using a computer.

### DISCLOSURE OF INVENTION

In order to solve the above-described problems, the present invention provides, for example, the following aspects.

A first aspect is a communication control system using both a Mobile IP and an SIP including: an authorization unit which receives a Mobile IP registration request message from a mobile communication terminal and conducts an authorization of the mobile communication terminal; an authorization information generation unit which generates authorization information for said authorization; an authorization information transmission unit which transmits the authorization information to the mobile communication terminal; and an authorization information checking unit which receives an SIP registration request message to which the authentication information is attached from the mobile communication terminal, checks the received authentication information and transmits an SIP registration completion message addressed to the mobile communication terminal.

A second aspect is a mobile communication terminal using both a Mobile IP and an SIP including: an authentication information storing unit which stores authentication information of the mobile communication terminal; a Mobile IP operation unit which, in Mobile IP registration steps, when receiving a Mobile IP registration reply message to which the authentication information is attached, reads the authentication information from the Mobile IP registration reply message to which the authentication information is attached and stores the read authentication information at the authentication information storing unit; and an SIP operation unit which starts an SIP registration operation after completion of registering the Mobile IP and which, in a transmission step of an SIP registration request message, reads the authentication information from the authentication information storing unit, attaches the read authentication information to the SIP registration request message and transmits the SIP registration request message to which the authentication information is attached.

A third aspect is a communication control system using both a Mobile IP and an SIP including: an SIP registration request message storing unit which receives a Mobile IP registration request message to which an SIP registration request message is attached from a mobile communication terminal and reads and stores the SIP registration request message; an authentication unit which receives the Mobile IP registration request message from the mobile communication terminal and conducts an authentication of the mobile communication terminal; an authentication information generation unit which generates authentication information with regard to the authentication; an SIP registration request message transmission unit which reads the SIP registration request message from the SIP registration request message storing unit, attaches the authentication information to the SIP registration request message and transmits the SIP registration request message; and an authentication information checking unit which receives the SIP registration request message to which the authentication information is attached from the SIP registration request message, checks the received authentication information and transmits an SIP registration completion message which is addressed to the mobile communication terminal.

A fourth aspect is a mobile communication terminal using both a Mobile IP and an SIP including: a Mobile IP operation portion which, when starting a Mobile IP registration operation, outputs a notation that indicates a start of the Mobile IP registration; and an SIP operation unit which, when receiving the notification, outputs an SIP registration operation message, wherein the Mobile IP operation unit, when receiving the SIP registration request message, attaches the SIP registration request message to a Mobile IP registration request message and transmits the Mobile IP registration request message to which the SIP registration request message is attached.

A fifth aspect is a communication control system using both a simple IP and an SIP including: an authentication unit which, in a PPP connection establishing step of simple IP registration steps with regard to a mobile communication terminal, conducts authorization of the mobile communication terminal; an authentication information generation unit which generates authentication information with regard to the authentication; an authorization information transmission unit which transmits the authorization information to the mobile communication terminal; and an authorization information checking unit which receives an SIP registration request message to which the authentication information is attached from the mobile communication terminal, checks the received authentication information and transmits an SIP registration completion message addressed to the mobile communication terminal.

A sixth aspect is a mobile communication terminal using both a simple IP and an SIP including: an authentication information storing unit which stores authentication information of the mobile communication terminal; a PPP operation unit which conducts an establishment of a PPP connection; a simple IP operation unit which, in a PPP connection establishing step of simple IP registration steps, when receiving a reply message to which authentication information is attached, reads the authentication information from the reply message to which the authentication information is attached and stores the read authentication information in the authentication information storing unit; and an SIP operation unit which starts an SIP registration operation after completion of registering the simple IP and which, in a transmission step of an SIP registration request message, reads the authentication information from the authentication information storing unit, attaches the read authentication information to the SIP registration request message and transmits the SIP registration request message to which the authentication information is attached.

A seventh aspect is the above-described communication control system further including a key attaching unit which attaches a key to the SIP registration completion message for encryption while conducting a communication by the mobile communication terminal.

An eighth aspect is the above-described mobile communication terminal, wherein when receiving the SIP registration completion message to which a key is attached via a wireless communication portion, the SIP operation unit reads the key from the SIP registration completion message to which the key is attached, stores the key and uses the key for encryption in following communication.

A ninth aspect is a computer program for conducting a communication operation using both a Mobile IP and SIP, including computer executable instructions for performing a function of transmitting authorization information to a communication terminal regarding authorization of the mobile communication terminal, wherein the authorization is conducted in response to a Mobile IP registration request message from the mobile communication terminal.

A tenth aspect is a computer program for conducting a communication operation using both a Mobile IP and SIP, including computer executable instructions for performing an authorization information checking function including steps of: receiving an SIP registration request message to which authorization information is attached from the mobile communication terminal; checking the received authorization information; and transmitting an SIP registration completion message which is addressed to the mobile communication terminal.

An eleventh aspect is a computer program for conducting a communication operation using both a Mobile IP and SIP, including computer executable instructions for: performing an SIP registration request message storing function including steps of: receiving a Mobile IP registration request message to which an SIP registration request is attached from a mobile communication terminal; and reading and storing the SIP registration request, and performing an SIP registration request message transmission function including steps of: attaching authentication information to the SIP registration request message; and transmitting the SIP registration request message, wherein the authentication information is used when authorizing the mobile communication terminal in response to the Mobile IP registration request from the mobile communication terminal.

A twelfth aspect is a computer program for conducting a communication operation using both a simple IP and SIP, including computer executable instructions for performing an authorization information transmission function including steps of transmitting authorization information to a mobile communication terminal, wherein the authentication information is used when authenticating the mobile communication terminal in a PPP connection establishment step of a simple IP registration step of the mobile communication terminal.

A thirteenth aspect is a computer program for conducting a communication operation using both a simple IP and SIP, including computer executable instructions for performing an authorization information checking function including steps of: receiving an SIP registration request message to which authorization information is attached from the mobile communication terminal; checking the received authorization information; and transmitting an SIP registration completion message which is addressed to the mobile communication terminal.

In accordance with the above-described aspects, it is possible to reduce a registration time of a Mobile IP/Simple IP and an SIP. Therefore, it is possible to reduce, for example, a time for starting a communication when a mobile node tries to initially connect to the “Visited Network” and a time in which a communication is blocked when conducting a handover, and hence, it is possible to improve communication service quality.

In addition, in accordance with the above-described aspects, it is possible to realize the above-described communication control system by using a computer.

### BRIEF DESCRIPTION OF THE DRAWINGS

FIG. 1 is a block diagram showing a constitution of a communication control system of a first embodiment.

FIG. 2 is a sequence chart showing registration steps of a Mobile IP and an SIP in the communication control system shown in FIG. 1.

FIG. 3 is a block diagram showing a constitution of a mobile node 10 of a first embodiment.

FIG. 4 is a block diagram showing a constitution of a communication control system of a second embodiment.

FIG. 5 is a sequence chart showing registration steps of a Mobile IP and an SIP in the communication control system shown in FIG. 4.

FIG. 6 is a block diagram showing a constitution of a mobile node 10a of a second embodiment.

FIG. 7 is a block diagram showing a constitution of a communication control system of a third embodiment.

FIG. 8 is a sequence chart showing registration steps of a simple IP and an SIP in the communication control system shown in FIG. 7.

FIG. 9 is a block diagram showing a constitution of a mobile node 10b of a third embodiment.

FIG. 10 is a constitutional drawing which explains a conventional registration constitution of both a Mobile IP and SIP in IMS/MMD.

FIG. 11 is a constitutional drawing which explains a conventional registration constitution of both a Mobile IP and SIP in IMS/MMD.

### DESCRIPTION OF THE REFERENCE SYMBOLS

10, 10a, 10b . . . mobile node (mobile communication terminal)
12, 12a . . . FA (authorization information transmission unit, SIP registration request message recording unit, SIP registration request message transmission unit)
14 . . . AAA (authorization unit, authorization information generation unit)
17 . . . S-CSCF (authorization information checking unit, key attachment unit)
22, 22a . . . Mobile IP operation portion
23, 23a . . . SIP operation portion
24 . . . authorization information storing portion
41 . . . PDSN (authorization information transmission unit)
51 . . . PPP operation portion
52 . . . Simple IP operation portion

### BEST MODE FOR CARRYING OUT THE INVENTION

Hereinafter, in reference to the drawings, preferable embodiments which are examples of the present invention are explained. It should be noted that the following embodiments are not limitations on the present invention, it is possible to, for example, add delete and replace constitutional elements of the embodiments, and it is possible to combine the constitutional elements if necessary.

### First Embodiment

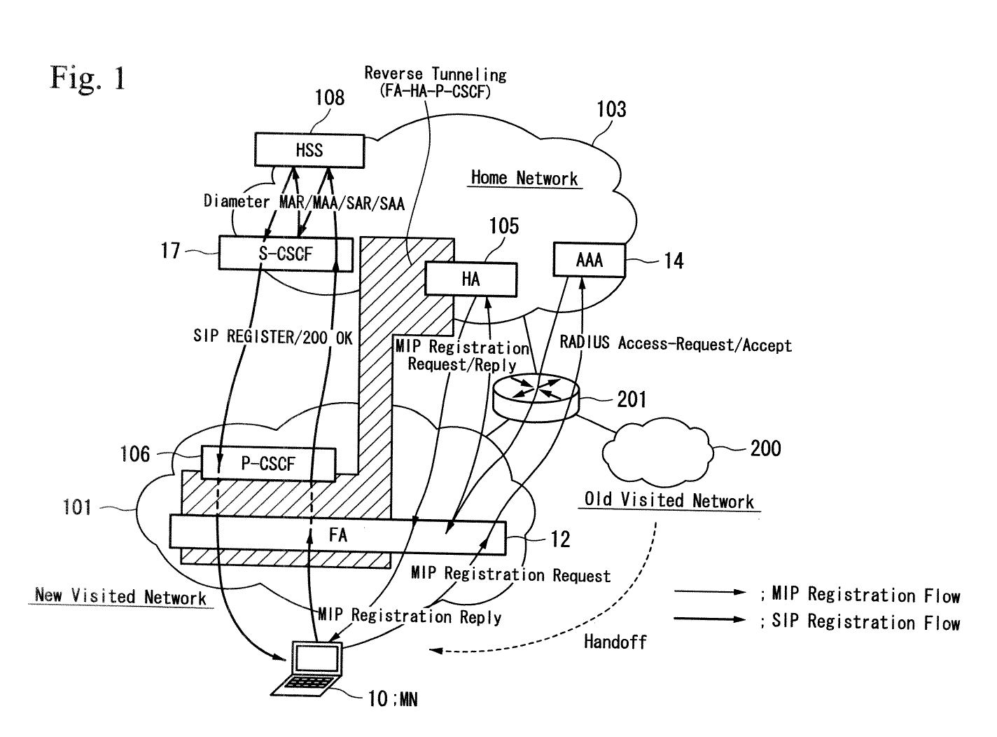

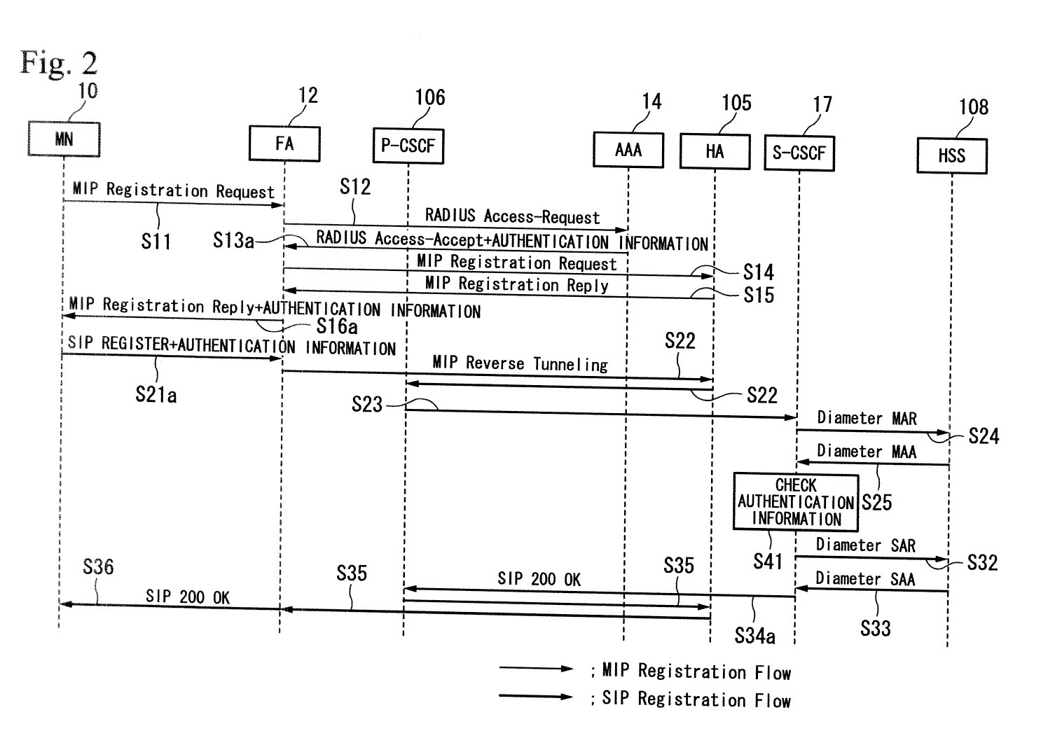

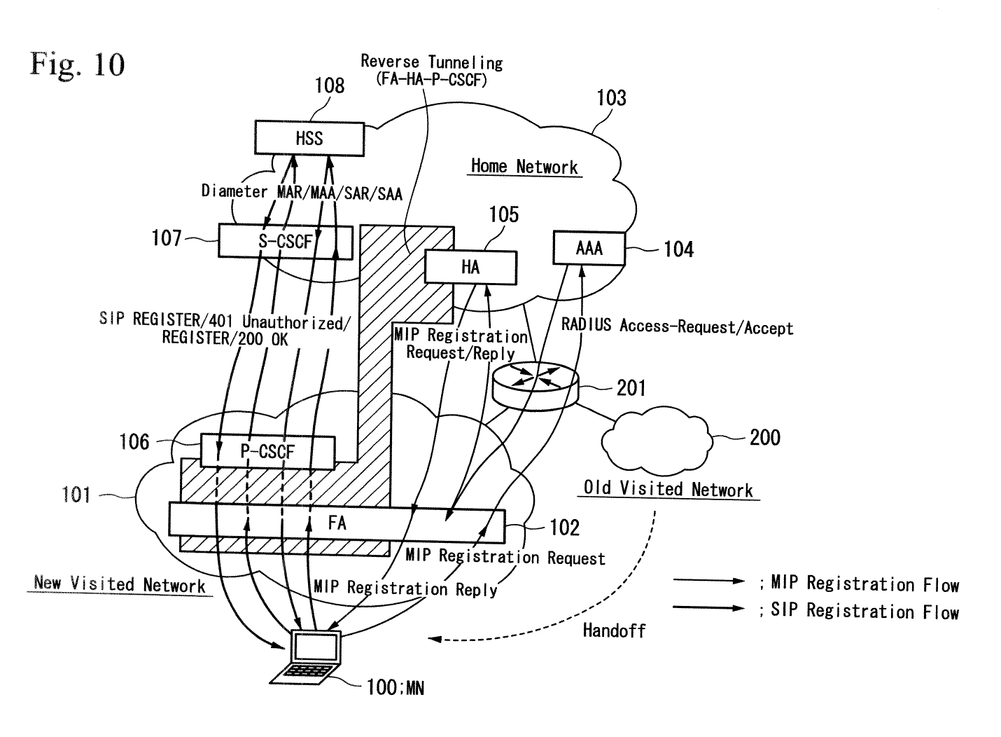

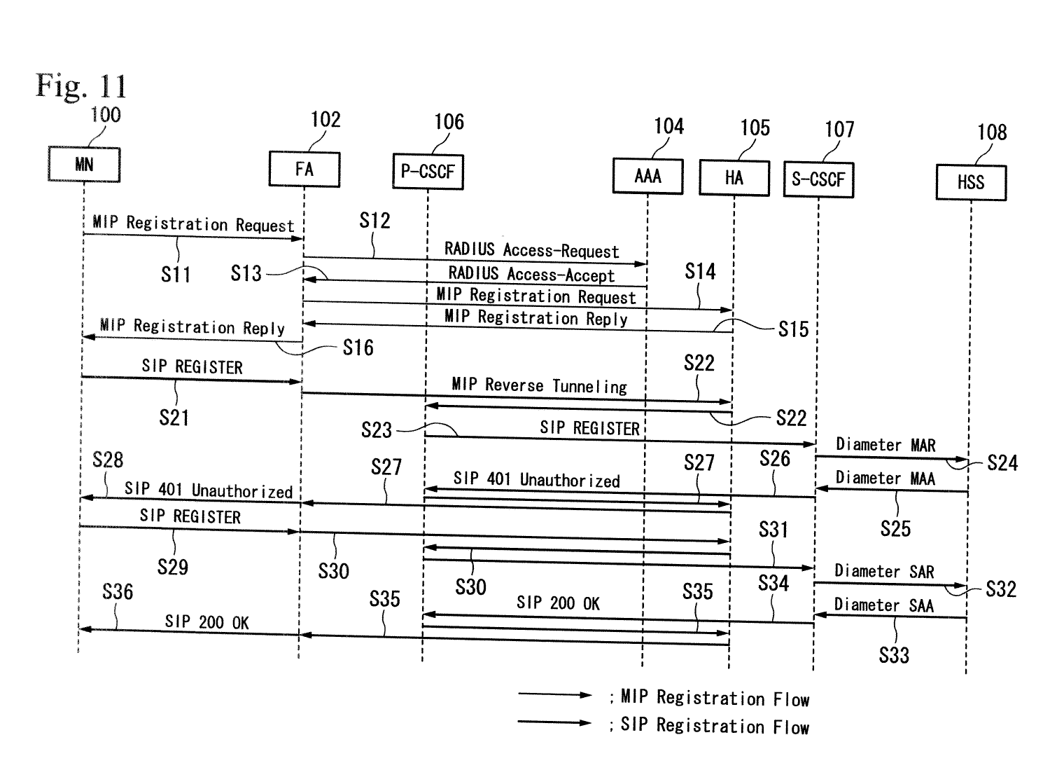

FIG. 1 is a block diagram showing a constitution of a communication control system of a first embodiment. This communication control system is a system of IMS/MMD using both a Mobile IP and an SIP. FIG. 2 is a sequence chart showing registration steps of a Mobile IP and an SIP in the communication control system shown in FIG. 1. In FIGS. 1 and 2, the same numerals are applied to portions that correspond to portions of FIGS. 10 and 11 and that are not changed.

In FIG. 1, a mobile node 10 conducts a handover from a “Visited Network (200)” from which the node moves to a “Visited Network (101)” which is a destination. The “Visited Network (101)” includes a FA 12 and a P-CSCF 106. A “Home Network (103)” of the mobile node 10 has an AAA 14, an HA 105, an S-CSCF 17 and an HSS 108. The “Visited Network (101)”, “Visited Network (200)” and “Home Network (103)” are connected to each other via a router 201. It should be noted that there is a possibility in which the P-CSCF 106 is provided by the “Home Network (103)”.

When the mobile node 10 conducts a handover toward the “Visited Network (101)”, first, the mobile node 10 registers a Mobile IP to the HA 105 of the “Home Network (103)” via the FA 12 of the “Visited Network (101)”.

Steps S11-S16a show registration steps of the Mobile IP of the first embodiment. First, the mobile node 10 transmits a Mobile IP registration request message to the FA 12 (S11). When receiving the Mobile IP registration request message, the FA 12 transmits a RADIUS access request message to the AAA 14 (S12). When receiving the RADIUS access request message, the AAA 14 conducts an authentication operation regarding the mobile node and transmits a RADIUS access acceptance message to the FA 12 if the authentication is successful (S13a). Here, the AAA 14 attaches the authentication information which indicates successful authentication of the mobile node to the RADIUS access acceptance message.

When receiving the RADIUS access acceptance message to which the authentication information is attached, the FA 102 transmits a Mobile IP registration request message to the HA 105 (S14). Here, the FA 12 reads and stores the authentication information from the RADIUS access acceptance message to which the authentication information is attached.

When receiving the Mobile IP registration request message, the HA 105 conducts a registration operation in accordance with the request and replies a Mobile IP registration reply message to the FA 12 (S15). When receiving the Mobile IP registration reply message, the FA 12 transmits the Mobile IP registration reply message to the mobile node 10 (S16a). Here, the FA 12 attaches the authentication information received at Step S13 to the Mobile IP registration reply message and transmits the Mobile IP registration reply message to the mobile node 10. When the mobile node 10 receives the Mobile IP registration reply message to which the authentication information is attached, the mobile node 10 reads and stores the authentication information. The stored authentication information is used at the following SIP registration operation.

Here, a registration of the mobile node 10 to the HA 105 is completed. After registering the Mobile IP, “Reverse Tunneling” as shown in FIG. 1 is provided for packet transmitting operations. Hereinafter, both the packets transmitted from the mobile node 10 and the packets transmitted to the mobile node 10 are transmitted by using the provided “Reverse Tunneling”. In a practical case, the packets transmitted from the mobile node 10 is transmitted to the HA 105 of the “Home Network (103)”, and then, transmitted to a node that is desired to be transmitted to. Similarly, a packet which is going to be transmitted to the mobile node 10 is transmitted to the HA 105 of the “Home Network (103)”, and then, transmitted to the mobile node 10.

After this, via the P-CSCF 106 of the “Visited Network (101)”, the mobile node 10 registers the SIP to the S-CSCF 17 of the “Home Network (103)”.

Steps S21a-S25, S41 and S32-S36 of FIG. 2 show a registration operation of the SIP in the first embodiment. First, the mobile node 10 prepares an SIP registration request message which is addressed to the S-CSCF 17 via the P-CSCF 106 and transmits the message via the FA 12 (S21a). Here, the mobile node 10 attaches the authentication information received and stored at Step S16a of the Mobile IP registration steps to the SIP registration request message.

The SIP registration request message to which the authentication information is attached is retransmitted by “Reverse Tunneling” to the P-CSCF 106 via the HA 105 (S22). The P-CSCF 106 transmits the SIP registration request message to which the authentication information is attached and which is retransmitted via the HA 105, to the S-CSCF 17 (S23). When the S-CSCF 17 receives the SIP registration request message to which the authentication information is attached and which is transmitted from the P-CSCF 106, the S-CSCF 17 requests node information to the HSS 108 regarding the mobile node from which the request message is originally transmitted (S24). Here, the S-CSCF 17 reads and stores the authentication information from the SIP registration request message to which the authentication information is attached.

In response to the request from the S-CSCF 17, the HSS 108 replies with the node information of the mobile node to the S-CSCF 17 (S25). When the S-CSCF 17 receives the node information form the HSS 108, the S-CSCF 17 stores the node information. Then, the S-CSCF 17 checks the authentication information received and stored at Step S23 (S41). Based on the checking result, if the authentication information indicates the successful authentication of the mobile node, the S-CSCF 17 requests the node information corresponding to the mobile node to the HSS 108 (S32). In response to the request from the S-CSCF 17, the HSS 108 conducts a node registration and responds with a node registration reply message to the S-CSCF 17 (S33).

When receiving the node registration reply message, the S-CSCF 17 transmits an SEP registration completion message which is addressed to the mobile node 10, to the P-CSCF 106 (S34a). Here, the S-CSCF 17 attaches a communication encryption key which is used in the following SIP steps and which corresponds to the mobile node, to the SIP registration completion message.

When receiving the SIP registration completion message to which the key is attached, the P-CSCF 106 transmits the SIP registration completion message which is addressed to the mobile node 10 (S35). The SIP registration completion message to which the key is attached is retransmitted to the FA 102 via the HA 105 by using the “Reverse Tunneling” (S35) and is transmitted to the mobile node 10 from the FA 12 (S36). When the mobile node 10 receives the SIP registration completion message to which the key is attached, the mobile node 10 reads and stores the key. The stored key is used for encryption in the following communication.

Here, an SIP registration of the mobile node 10 to the S-CSCF 17 is completed. Then, the mobile node 10 can communicate on the “Visited Network”.

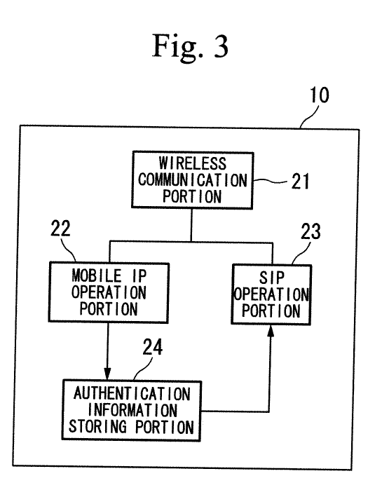

FIG. 3 is a block diagram showing a constitution of the mobile node 10 of the first embodiment. In FIG. 3, the mobile node 10 has a wireless communication portion 21, a Mobile IP operation portion 22, an SIP operation portion 23 and an authorization information storing portion 24. The Mobile IP operation portion 22 conducts operations with regard to the Mobile IP, for example, a Mobile IP registration operation. The SIP operation portion 23 conducts operations with regard to the SIP, for example, an SIP registration operation. The authentication information storing portion 24 stores the authentication information of the mobile node to which the authentication information storing portion 24 belongs.

In the Mobile IP registration steps, when receiving the Mobile IP registration reply message to which the authentication information is attached via the wireless communication portion 21, the Mobile IP operation portion 22 reads the authentication information from the Mobile IP registration reply message to which the authentication information is attached and stores the read authentication information in the authentication information storing portion 24.

When the Mobile IP registration is finished, the SIP operation portion 23 starts the SIP registration operation. In a transmission step of the SIP registration request message, the SIP operation portion 23 reads the authentication information from the authentication information storing portion 24, attaches the read authentication information to the SIP registration request message and transmits the SIP registration request message to which the authentication information is attached via the wireless communication portion 21.

In addition, when receiving the SIP registration completion message to which the key is attached via the wireless communication portion 21, the SIP operation portion 23 reads and stores the key from the SIP registration completion message to which the key is attached. The SIP operation portion 23 uses the stored key for communication in the following communication.

In accordance with the above-described first embodiment, the authentication information of the mobile node generated when the Mobile IP is registered is used upon registering the SIP. Therefore, the authentication of the mobile node is conducted only once when the Mobile IP is registered, hence, it is possible to reduce an operation time of authenticating the mobile node. In addition, it is possible to reduce communication time because a communication via the “Home Network” by using the “Reverse Tunneling” for the challenge-response authentication on the mobile node upon registering the SIP is omitted.

It should be noted that the authentication information of the mobile node upon registering the Mobile IP can be an authentication certification issued by the AAA including the signature of the AAA or can be simple information which indicates successful authentication of the mobile node (for example, a combination of an identifier of the mobile node and a flag that indicates successful authentication). For example, the FA 12 receives a notification indicating successful authentication from the AA 14, and it is possible to generate a combination of the identifier of the mobile node on which the authentication is successful and a flag that indicates successful authentication. In such a case, the FA 12 has a function of an authentication information generation unit.

In addition, in the above-described first embodiment, the FA 12 stores the authentication information of the mobile node received at Step S13a and attaches the stored authentication information to the Mobile IP registration reply message which is transmitted at Step S16a, but it is sufficient to transmit the authentication information of the mobile node to that mobile node. For example, it can be another solution in which the authentication information of the mobile node received at Step S13a by the FA 12 is attached to the Mobile IP registration request message which is transmitted at Step S14, the HA 15 attaches the authentication information attached to the Mobile IP registration request message to the Mobile IP registration reply message, and the Mobile IP registration reply message to which the authentication information is attached is retransmitted to the mobile node.

### Second Embodiment

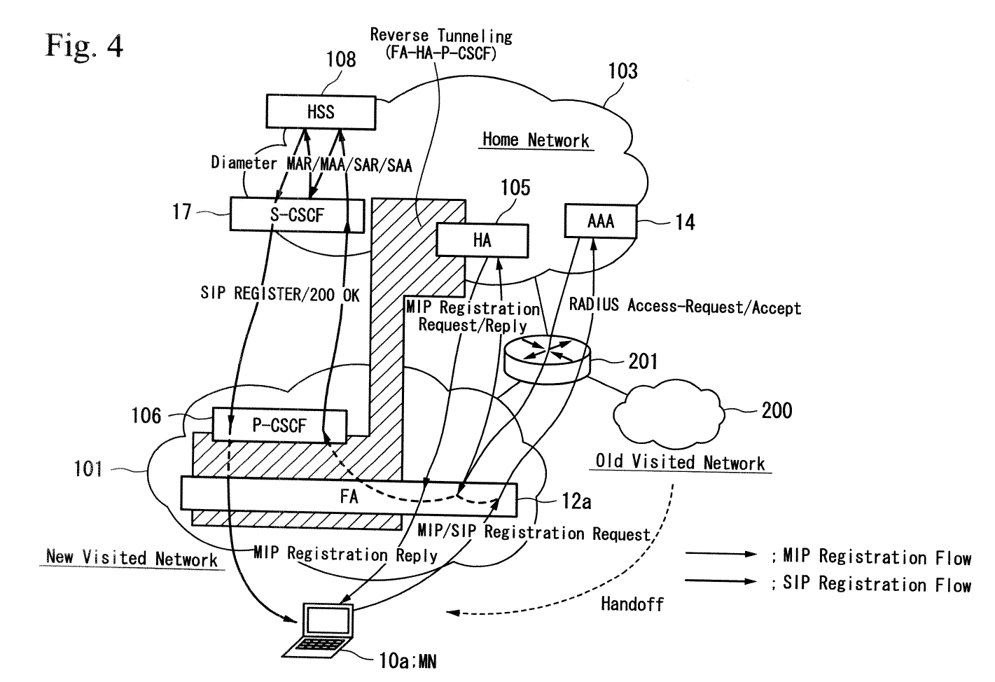

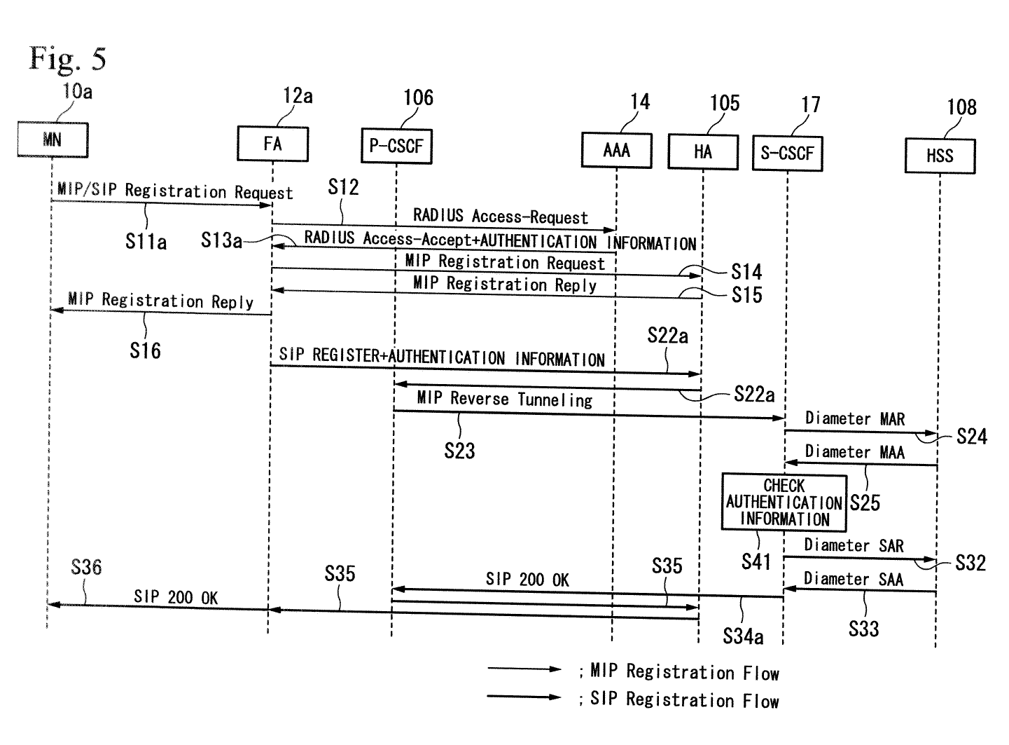

FIG. 4 is a block diagram showing a constitution of a communication control system of a second embodiment. Same as the first embodiment, this communication control system is a system of IMS/MMD using both a Mobile IP and an SIP. FIG. 5 is a sequence chart showing registration steps of the Mobile IP and SIP in the communication control system shown in FIG. 4. In FIGS. 4 and 5, the same numerals are applied to portions that correspond to portions of FIGS. 1 and 2, and explanations of them are omitted.

In FIG. 4, a mobile node 10a and a FA 12a are differences from the first embodiment shown in FIG. 1. These changed points are explained in reference to FIG. 5. First, the mobile node 10a transmits a Mobile IP registration request message to the FA 12a (S11a). In this operation, the mobile node 10a attaches the SIP registration request message to the Mobile IP registration request message.

When receiving the Mobile IP registration request message to which the SIP registration request message is attached, the FA 12a transmits a RADIUS access request message to the AAA 14 (S12). In this operation, the FA 12a reads and stores the SIP registration request message from the Mobile IP registration request message to which the SIP registration request message is attached.

After this, when receiving the RADIUS access acceptance message to which the authentication information is attached from the AAA 14 (S13a), the FA 12a transmits the Mobile IP registration request message to the HA 105 (S14) and reads and stores the authentication information from the RADIUS access acceptance message to which the authentication information is attached. The stored authentication information is used at a following SIP registration operation.

After this, when receiving the Mobile IP registration reply message from the AAA 14, the FA 12a transmits the Mobile IP registration reply message to the mobile node 10a (S16). Here, a registration of the mobile node 10a to the HA 105 is completed.

After this, the FA 12a transmits the SIP registration request message received and stored at Step S11a to the S-CSCF 17 via the P-CSCF 106 (S22a). Here, the FA 12a attaches the authorization information received and stored at Step S13a to the SIP registration request message. The SIP registration request message to which the authentication information is attached is retransmitted by “Reverse Tunneling” to the P-CSCF 106 via the HA 105 (S22a). The P-CSCF 106 transmits the retransmitted SIP registration request message to which the authentication information is attached, to the S-CSCF 17 (S23). Following steps (Steps S24, S25, S41, S32-S36) are the same as the first embodiment shown in FIG. 2.

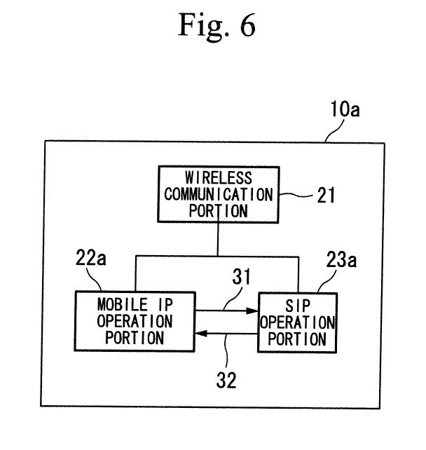

FIG. 6 is a block diagram showing a constitution of a mobile node 10a of a second embodiment. The mobile node 10a shown in FIG. 6 has the same constitution as the mobile node 10 shown in FIG. 3, but the mobile node 10a does not have the authentication information storing portion 24.

In FIG. 6, after starting the Mobile IP registration operation, the Mobile IP operation portion 22a outputs a notation 31 that indicates a start of the Mobile IP registration to the SIP operation portion 23a. When receiving the notification 31, the SIP operation portion 23a outputs an SIP registration request message 32 to the Mobile IP operation portion 22a. When receiving the SIP registration request message 32, the Mobile IP operation portion 22a attaches the SIP registration request message 32 to the Mobile IP registration request message and transmits the Mobile IP registration request message to which the SIP registration request message is attached via the wireless communication portion 21. It should be noted that it is possible to store the SIP registration request message at, for example, an extended area of the Mobile IP registration request message.

In accordance with the above-described second embodiment, similar to the first embodiment, it is possible to reduce an operation time of authenticating the mobile node. In addition, in the second embodiment, the SIP registration request message is attached to the Mobile IP registration request message which is transmitted from the mobile node, the SIP registration request message is separated by the FA from the Mobile IP registration request message to which the SIP registration request message is attached, and the SIP registration is requested after completion of the SIP registration. In accordance with such a constitution, communication steps of the mobile node are simplified, hence, it is possible to further reduce the time to register both the Mobile IP and SIP.

### Third Embodiment

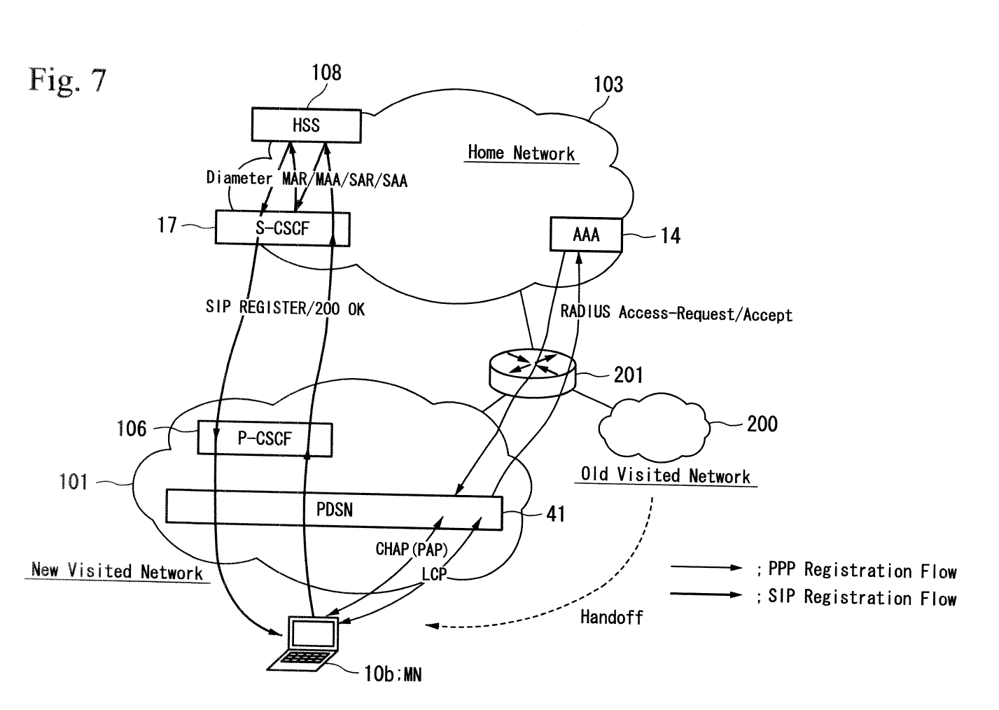

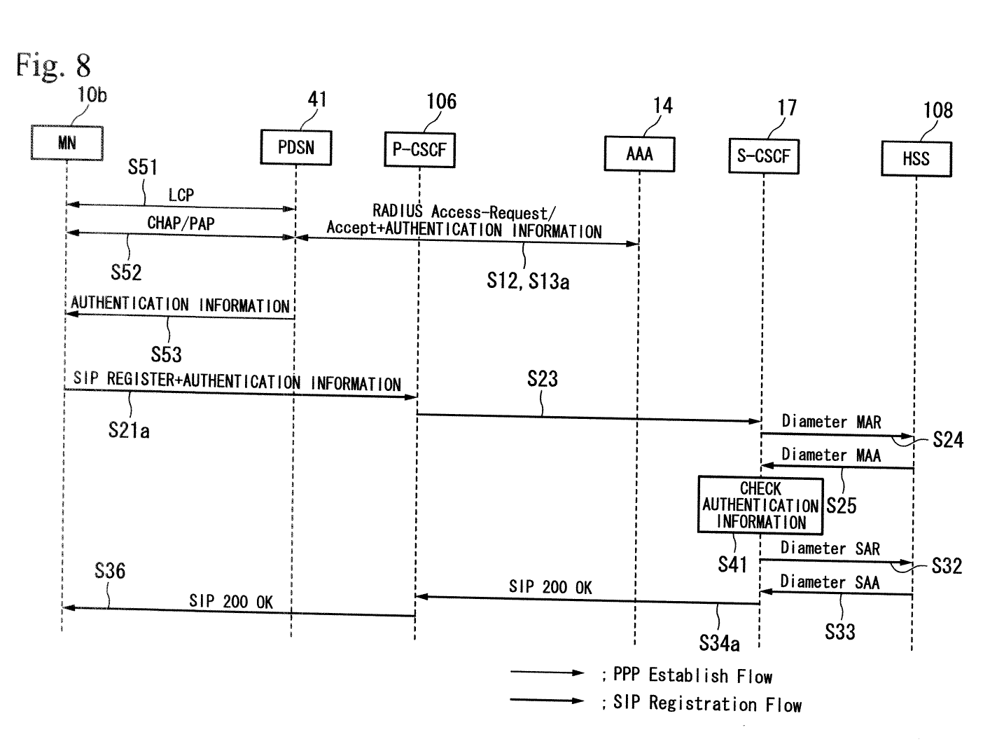

FIG. 7 is a block diagram showing a constitution of a communication control system of a third embodiment of the present invention. This communication control system is a system of IMS/MMD using both a simple IP and an SIP. FIG. 8 is a sequence chart showing registration steps of a simple IP and an SIP in the communication control system shown in FIG. 7. In FIGS. 7 and 8, the same numerals are applied to portions that correspond to portions of FIGS. 1 and 2, and explanations of them are omitted.

In FIG. 7, the “Visited Network (101)” includes a PDSN (Packet Data Serving Node) 41. In FIG. 8, when registering a simple IP, the mobile node 10b establishes a PPP (Point to Point Protocol) connection to the PDSN 41 (S51 and 52). Here, the PDSN 41 requests the AAA 14 to conduct an authorization with regard to the mobile node 10b (S12). In response to the request, the AAA 14 conducts the authorization with regard to the mobile node and responds a reply message to which the authentication information of the mobile node is attached to the PDSN 41 if the authentication is successful (S13a). The PDSN 41 transmits the authentication information which is transmitted from the AAA 14 to the mobile node 10b (S53). The mobile node 10b stores the authentication information transmitted from the PDSN 41. The stored authentication information is used at following SIP registration steps. It should be noted that the SIP registration steps (S21a-S36) are the same as FIG. 2 of the first embodiment.

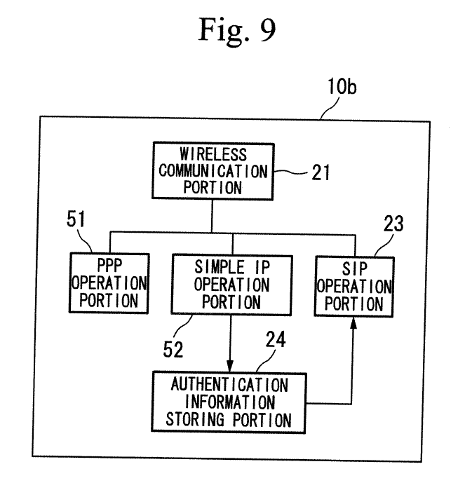

FIG. 9 is a block diagram showing a constitution of a mobile node 10b of the third embodiment of the present invention. In FIG. 9, the mobile node 10b has a wireless communication portion 21, a PPP operation portion 51, a simple IP operation portion 52, an SIP operation portion 23 and an authorization information storing portion 24. The PPP operation portion 51 conducts operations with regard to PPP, for example, a PPP connection establishment. The simple IP operation portion 52 conducts operations with regard to the simple IP, for example, a simple IP registration operation. The SIP operation portion 23 conducts operations with regard to the SIP, for example, an SIP registration operation. The authentication information storing portion 24 stores the authentication information of the mobile node to which the authentication information storing portion 24 belongs.

In the simple IP registration steps, the PPP operation portion 51 establishes a PPP connection to the PDSN 41 through the wireless communication portion 21. In the PPP connection step of the simple IP registration steps, when receiving a reply message to which the authentication information is attached through the wireless communication portion 21, the simple IP operation portion 52 reads the authentication information from the reply message to which the authentication information is attached and stores the read authentication message at the authentication information storing portion 24.

When the simple IP registration is finished, the SIP operation portion 23 starts the SIP registration operation. In a transmission step of the SIP registration request message, the SIP operation portion 23 reads the authentication information from the authentication information storing portion 24, attaches the read authentication information to the SIP registration request message and transmits the SIP registration request message to which the authentication information is attached via the wireless communication portion 21.

In addition, when receiving the SIP registration completion message to which the key is attached via the wireless communication portion 21, the SIP operation portion 23 reads and stores the key from the SIP registration completion message to which the key is attached. The SIP operation portion 23 uses the stored key for communication in the following communication.

In accordance with the above-described third embodiment, the authentication information of the mobile node generated when the simple IP is registered is used upon registering the SIP. Therefore, the authentication of the mobile node is conducted only once when the simple IP is registered; hence, it is possible to reduce an operation time of authenticating the mobile node. In addition, it is possible to reduce communication time because a communication for the challenge-response authentication on the mobile node upon registering the SIP is omitted.

It should be noted that, in the third embodiment, it is possible for the AAA 14 to generate the authentication information of the mobile node, or it is possible for the PDSN 41 to generate the authentication information indicating a successful authentication of the mobile node based on a notation of successful authentication received from the AAA 14. In such a case, the PDSN 41 has a function as an authentication information generation unit.

As described above, in accordance with the embodiments of the present invention, it is possible to reduce a registration time of a Mobile IP/Simple IP and an SIP. Therefore, it is possible to reduce, for example, a time for starting a communication when a mobile node tries to initially connect to the “Visited Network” and a time in which a communication is blocked when conducting a handover, and hence, it is possible to improve communication service quality.

It should be noted that if a computer program for realizing each step shown in FIG. 2, 5 or 8 is stored in a computer readable medium, it is possible to conduct the communication control operation by a computer system which reads the computer program stored in the computer readable medium. It should be noted that the “computer system” can include an OS and hardware, for example, peripheral devices.

In addition, the “computer readable medium” can be a non-volatile memory, for example, a flexible disc, optical-magneto disc, ROM and flash memory, a movable medium, for example, CD-ROM, and a storage device, for example, a hard disc installed inside the computer system.

In addition, the “computer readable medium” includes a case of temporally storing or memorizing a computer program for a certain time, for example, a volatile memory (for example, DRAM (Dynamic Random Access Memory)) inside a computer system used as a server or a client by which a computer program is transmitted via a network, for example, the Internet, or via a communication line, for example, a telephone line.

In addition, it is possible to transmit the above-described computer program from the computer system storing the computer program inside such as a storage device to other computer system via a transmission medium or via transmission wave inside the transmission medium. Here, the “transmission medium” via which the computer program is transmitted is a medium that has a function of transmitting information, for example, a network (communication network) such as Internet, or a communication line such as a telephone line.

In addition, it is possible that the above-described computer program be provided to achieve a portion of the above-described functions. Further, the computer program can be combined with another computer program that is stored in the computer system beforehand to achieve the above-described functions, that is, the computer program can be a differential file (differential program).

As shown above, the embodiments of the present invention are explained in reference to the drawings, and the embodiments are not limitations on a practical constitution of the present invention which can include changes on the constitution if such changes are involved in the idea of the present invention.

For example, in the above-described embodiments, a wireless communication terminal using wireless communication lines is shown as an example of the mobile node (mobile communication terminal), but the wireless communication terminal is not a limitation on the mobile node, and a communication terminal using a wire communication can be the mobile node.

In addition, in the above-described embodiments, IMS/MMD is shown as an example, and in a similar manner, the above-described embodiments can be applied to a communication control system that uses both the simple IP and the SIP. It should be noted that the constitutional elements (for example, P-CSCF and S-CSCF) used in the above-described embodiments are used in the IMS/MMD, and there is a possibility that, in a generally used communication control system using the SIP, these constitutional elements have different names, and that some of these constitutional elements are not provided.

It should be noted that, in FIG. 1, for example, the above-described mobile node 10a/b seems to be a laptop personal computer, but this is not a limitation. For example, the mobile node 10a/b can be a cellular phone, a PHS (Personal Handy-phone System), etc. Further, for example, the mobile node 10a/b can be a computer installed in a car such as a car navigation system.

### INDUSTRIAL APPLICABILITY

In accordance with the above-described embodiments, it is possible to reduce the registration time of a Mobile IP/Simple IP and an SIP. Therefore, it is possible to reduce, for example, a time for starting a communication when a mobile node tries to initially connect to the “Visited Network” and a time in which a communication is blocked when conducting a handover, and hence, it is possible to improve communication service quality.

1. A communication control system using both a Mobile IP and an SIP comprising:
an authorization unit which receives a Mobile IP registration request message from a mobile communication terminal and conducts an authorization of the mobile communication terminal;
an authorization information generation unit which generates authorization information for said authorization;
an authorization information transmission unit which transmits the authorization information to the mobile communication terminal; and
an authorization information checking unit which receives an SIP registration request message to which the authentication information is attached from the mobile communication terminal, checks the received authentication information and transmits an SIP registration completion message addressed to the mobile communication terminal.

2. A mobile communication terminal using both a Mobile IP and an SIP comprising:
an authentication information storing unit which stores authentication information of the mobile communication terminal;
a Mobile IP operation unit which, in Mobile IP registration steps, when receiving a Mobile IP registration reply message to which the authentication information is attached, reads the authentication information from the Mobile IP registration reply message to which the authentication information is attached and stores the read authentication information at the authentication information storing unit; and
an SIP operation unit which starts an SIP registration operation after completion of registering the Mobile IP and which, in a transmission step of an SIP registration request message, reads the authentication information from the authentication information storing unit, attaches the read authentication information to the SIP registration request message and transmits the SIP registration request message to which the authentication information is attached.

3. A communication control system using both a Mobile IP and an SIP comprising:
an SIP registration request message storing unit which receives a Mobile IP registration request message to which an SIP registration request message is attached from a mobile communication terminal and reads and stores the SIP registration request message;
an authentication unit which receives the Mobile IP registration request message from the mobile communication terminal and conducts an authentication of the mobile communication terminal;
an authentication information generation unit which generates authentication information with regard to the authentication;
an SIP registration request message transmission unit which reads the SIP registration request message from the SIP registration request message storing unit, attaches the authentication information to the SIP registration request message and transmits the SIP registration request message; and
an authentication information checking unit which receives the SIP registration request message to which the authentication information is attached from the SIP registration request message, checks the received authentication information and transmits an SIP registration completion message which is addressed to the mobile communication terminal.

4. A mobile communication terminal using both a Mobile IP and an SIP comprising:
a Mobile IP operation portion which, when starting a Mobile IP registration operation, outputs a notation that indicates a start of the Mobile IP registration; and
an SIP operation unit which, when receiving the notification, outputs an SIP registration operation message, wherein
the Mobile IP operation unit, when receiving the SIP registration request message, attaches the SIP registration request message to a Mobile EP registration request message and transmits the Mobile IP registration request message to which the SIP registration request message is attached.

5. A communication control system using both a simple IP and an SIP comprising:
an authentication unit which, in a PPP connection establishing step of simple IP registration steps with regard to a mobile communication terminal, conducts authorization of the mobile communication terminal;
an authentication information generation unit which generates authentication information with regard to the authentication;
an authorization information transmission unit which transmits the authorization information to the mobile communication terminal; and
an authorization information checking unit which receives an SIP registration request message to which the authentication information is attached from the mobile communication terminal, checks the received authentication information and transmits an SIP registration completion message addressed to the mobile communication terminal.

6. A mobile communication terminal using both a simple IP and an SIP comprising:
an authentication information storing unit which stores authentication information of the mobile communication terminal;
a PPP operation unit which conducts an establishment of a PPP connection;
a simple IP operation unit which, in a PPP connection establishing step of simple IP registration steps, when receiving a reply message to which authentication information is attached, reads the authentication information from the reply message to which the authentication information is attached and stores the read authentication information in the authentication information storing unit; and
an SIP operation unit which starts an SIP registration operation after completion of registering the simple IP and which, in a transmission step of an SIP registration request message, reads the authentication information from the authentication information storing unit, attaches the read authentication information to the SIP registration request message and transmits the SIP registration request message to which the authentication information is attached.

7. A communication control system according to claim 1 or 3, further comprising a key attaching unit which attaches a key to the SIP registration completion message for encryption while conducting a communication by the mobile communication terminal.

8. A mobile communication terminal according to claim 4 or 6, wherein
when receiving the SIP registration completion message to which a key is attached via a wireless communication portion, the SIP operation unit reads the key from the SIP registration completion message to which the key is attached, stores the key and uses the key for encryption in following communication.

9. A computer or conducting a communication operation using both a Mobile IP and SIP, comprising computer executable instructions for performing a function of transmitting authorization information to a communication terminal regarding authorization of the mobile communication terminal, wherein the authorization is conducted in response to a Mobile IP registration request message from the mobile communication terminal.

10. A computer program for conducting a communication operation using both a Mobile IP and SIP, comprising computer executable instructions for performing an authorization information checking function including steps of:
receiving an SIP registration request message to which authorization information is attached from the mobile communication terminal;
checking the received authorization information; and
transmitting an SIP registration completion message which is addressed to the mobile communication terminal.

11. A computer program for conducting a communication operation using both a Mobile IP and SIP, comprising computer executable instructions for:
performing an SIP registration request message storing function including steps of:
receiving a Mobile IP registration request message to which an SIP registration request is attached from a mobile communication terminal; and
reading and storing the SIP registration request, and
performing an SIP registration request message transmission function including steps of:
attaching authentication information to the SIP registration request message; and
transmitting the SIP registration request message, wherein
the authentication information is used when authorizing the mobile communication terminal in response to the Mobile IP registration request from the mobile communication terminal.

12. A computer program for conducting a communication operation using both a simple IP and SIP, comprising computer executable instructions for performing an authorization information transmission function including steps of transmitting authorization information to a mobile communication terminal, wherein
the authentication information is used when authenticating the mobile communication terminal in a PPP connection establishment step of a simple IP registration step of the mobile communication terminal.

13. A computer program for conducting a communication operation using both a simple IP and SIP, comprising computer executable instructions for performing an authorization information checking function including steps of:
receiving an SIP registration request message to which authorization information is attached from the mobile communication terminal;
checking the received authorization information; and
transmitting an SIP registration completion message which is addressed to the mobile communication terminal.
